(19) United States
(12) Patent Application Publication
(10) Pub. No.: US 2017/0366479 A1
(43) Pub. Date: Dec. 21, 2017

(54) Communication System

(71) Applicant: Microsoft Technology Licensing, LLC, Redmond, WA (US)

(72) Inventors: Mohammed Ladha, London (GB); Farookh P. Mohammed, Woodinville, WA (US); Konstantin Lutskiy, Prague (CZ); Alexey Pikin, Prague (CZ); Maxim Anatolyevich Silchev, Prague (CZ)

(73) Assignee: Microsoft Technology Licensing, LLC, Redmond, WA (US)

(21) Appl. No.: 15/187,330

(22) Filed: Jun. 20, 2016

(51) Int. Cl. H04L 12/58

(52) U.S. Cl. CPC H04L 51/02; H04L 51/30

(57) ABSTRACT

A computer system comprises computer storage holding at least one code module configured to implement a bot, and at least one processor configured to execute the code module. The computer system also comprises a communication system for effecting communication events between users of the communication system; a bot interface for exchanging messages between the communication system and the bot; and a dialogue manager. The communication system transmits, to the dialogue manager directly, content of a first message received at a processor of the communication system from a user of the communication system. The dialogue applies an intent recognition process to the content to generate at least one intent identifier, and transmits a second message comprising the intent identifier to the bot using the bot interface. The bot automatically generates a response using the intent identifier received in the second message, and transmits the generated response to at least the user.

### TECHNICAL FIELD

The present invention relates to a communication system for effecting communication events between users, and in particular to mechanisms by which the communication system can be used to allow bots (i.e. autonomous software agents) to participate in those communication events.

### BACKGROUND

Communication systems allow users to communicate with each other over a communication network e.g. by conducting a communication event over the network. The network may be, for example, the Internet or public switched telephone network (PSTN). During a call, audio and/or video signals can be transmitted between nodes of the network, thereby allowing users to transmit and receive audio data (such as speech) and/or video data (such as webcam video) to each other in a communication session over the communication network.

Such communication systems include Voice or Video over Internet protocol (VoIP) systems. To use a VoIP system, a user installs and executes client software on a user device. The client software sets up VoIP connections as well as providing other functions such as registration and user authentication. In addition to voice communication (or alternatively), the client may also set up connections for communication events, for instant messaging (“IM”), screen sharing, or whiteboard sessions.

A communication event may be conducted between a user(s) and a “bot”, which is and intelligent, autonomous software agent. A bot is an autonomous computer program that carries out tasks on behalf of users in a relationship of agency. The bot runs continuously for some or all of the duration of the communication event, awaiting messages which, when detected, trigger automated tasks to be performed in response to those messages by the bot. A bot may exhibit artificial intelligence (AI), whereby it can simulate certain human intelligence processes, for example to generate human-like responses to messages sent by the user in the communication event, thus facilitating a two-way conversation between the user and the bot via the network. That is, to generate responses to messages automatically so as provide a realistic conversational experience for the user based on natural language.

### SUMMARY

A first aspect of the present invention is directed to a computer system comprising computer storage holding at least one code module configured to implement a bot, and at least one processor configured to execute the code module. The computer system also comprises a communication system for effecting communication events between users of the communication system; a bot interface for exchanging messages between the communication system and the bot; and a dialogue manager. The communication system is configured to transmit, to the dialogue manager directly, content of a first message received at a processor of the communication system from a user of the communication system. The dialogue manager is configured to apply an intent recognition process to the content of the first message to generate at least one intent identifier, and transmit a second message comprising the intent identifier to the bot using the bot interface. The bot is configured, in response to receiving the second message, to automatically generate a response using the intent identifier received in the second message, and transmit the generated response to at least the user.

Transmitting the message content to the dialogue manager directly (rather than to the bot itself) in order to pre-apply intent recognition allows the time it takes between a user transmitting a message and the bot responding to be reduced.

For example, in preferred embodiments:
the processor of the communication system is located in a data center, and the dialogue manager is implemented by a processor located in the same data center, the content being transmitted via an internal service-to-service connection of the data center, or
the processor of the communication system is located in a data center, and the dialogue manager is implemented by a processor located in a collocated data center, the content being transmitted via a dedicated backbone connection between the data center and the collocated data center, or
the dialogue manager is implemented on the processor that receives the message (i.e. the same processor).

These embodiments allow the message content to be communicated to the dialogue manager extremely quickly, as compared with (say) a round trip time over the public Internet between the bot and a third party intent recognition service.

The term “direct” means that the first message, when received at the processor of the communication system, is transmitted to the dialogue manager without going via the bot. That is, such that the bot does not have to invoke the dialogue manager itself.

For example, the first message may be transmitted from the user to the communication system and the second message may be transmitted from the dialogue manager to the bot via a packet based computer network (e.g. the Internet). In this case, the first message may not be transmitted from the processor at which it is received to the dialogue manager via that network (e.g. the Internet). That is, it may be transmitted via a connection other than that network (e.g. the Internet), i.e. without going via that network, e.g. not via the Internet.

In embodiments, the dialogue manager may be configured to determine a score for the intent identifier, which is included in the second message.

The dialogue manager may be configured to determine at least one entity associated with the intent data, and to generate an identifier of the entity, which is included in the second message.

The dialogue manager may be configured to include in the second message:
a type of the entity,
a score for the entity,
a description of the entity in a standardised format, and/or
an identifier of a position at which the entity is mentioned in a character string of the content.

That is, one or more of the above may be included in the second message.

The bot interface may be an API and the content of the first message may be transmitted directly to the dialogue manager by the communication system instigating an intent recognition function of the bot API.

For example, the communication system may comprise a communication API and the communication service is configured to instigate a function of the communication API in response to receiving the first messages, which causes the communication API to instigate the intent recognition function to transmit the content of the first message directly to the dialogue manager.

The content of the message may comprise a character string.

The content of the message may comprise audio and/or video data.

The audio and/or video data may be real-time data.

The first message may be transmitted from the user to the communication system and the second message is be transmitted from the dialogue manager to the bot via a packet based computer network (e.g. the Internet), wherein the first message is not transmitted from the processor to the dialogue manager via that network (e.g. such that the first message is not transmitted from the processor to the dialogue manager via the Internet).

The bot may be configured to transmit the generated response to at least the user using the bot interface. For example, said transmitting of the generated response by the bot to the user using the bot interface may comprise using the bot interface to transmit the response to the communication system for relaying to the user, and the communication system may be configured to relay the response to the user.

A second aspect of the present invention is directed to a computer-implemented method of effecting a communication event between at least one user of a communication system and at least one bot, the at least one bot being implemented by at least one code module executed on at least one processor, the method comprising implementing, by the communication system, the following steps: receiving a first message at a processor of the communication system from the user of the communication system; transmitting directly to a dialogue manager of the communication system content of the first message received at the processor; applying, by the dialogue manager, an intent recognition process to the content of the first message to generate at least one intent identifier; and transmitting from the dialogue manager to the bot a second message comprising the intent identifier, using a bot interface of the communication system, the intent identifier in the second message for use by the bot in automatically generating a response to the second message for transmission to the user.

A third aspect of the present invention is directed to a computer program product comprising system code stored on a computer readable storage medium, the system code for effecting a communication event between at least one user of a communication system and at least one bot, the at least one bot being implemented by at least one code module executed on at least one processor; wherein a first portion of the system code is configured when executed at the communication system to implement a dialogue manager; wherein a second portion of the code is configured when executed on a processor of the communication system to implement steps of receiving a first message at the processor from a user of the communication system, and transmitting directly to the dialogue manager content of the first message received at the processor; and wherein the dialogue manager is configured to apply an intent recognition process to the content of the first message to generate at least one intent identifier, and to transmit to the bot a second message comprising the intent identifier, using a bot interface of the communication system, the intent identifier in the second message for use by the bot in automatically generating a response to the second message for transmission to the user.

A fourth aspect of the present invention is directed to a computer system for effecting communications between users of the communication system and a plurality of bots, the bots being implemented as a plurality of code modules executed on one or more processors, the computer system comprising a communication system for effecting communication events between users of the communication system; a bot interface for exchanging messages between the communication system and the bot; and a dialogue manager. The communication system is configured to transmit, to the dialogue manager directly, content of a first message received at a processor of the communication system from a user of the communication system. The dialogue manager is configured to apply an intent recognition process to the content of the first message to generate at least one intent identifier, and transmit a second message comprising the intent identifier to the bot using the bot interface, the intent identifier in the second message for use by the bot in automatically generating a response to the second message for transmission to the user.

In embodiments of the second, third or fourth aspects, any feature of the first aspect or any embodiment thereof may be implemented.

### BRIEF DESCRIPTION OF FIGURES

For a better understanding of the present invention, and to show how embodiments of the same may be carried into effect, reference is made to the following figures in which:

FIG. 1 shows a block diagram of a computer system, which includes a communication system and at least one bot;

FIG. 2A shows a schematic block diagram of a data center;

FIG. 2B shows a schematic block diagram of a processor of a data center;

FIG. 2C shows a high level schematic representation of a system architecture;

FIG. 3A shows a more detailed schematic representation of a system architecture;

FIG. 3B shows a modified system architecture according to embodiments of the present invention;

FIG. 4A shows an example signaling flow between a user and a bot via a dialogue manager;

FIG. 4B illustrates aspects of the structure of a message generated by a dialogue manager;

FIG. 4C shows an example message generated by a dialogue manager;

FIG. 5A shows a schematic block diagram of a user device;

FIG. 5B shows an example graphical user interface.

### DETAILED DESCRIPTION OF EXAMPLE EMBODIMENTS

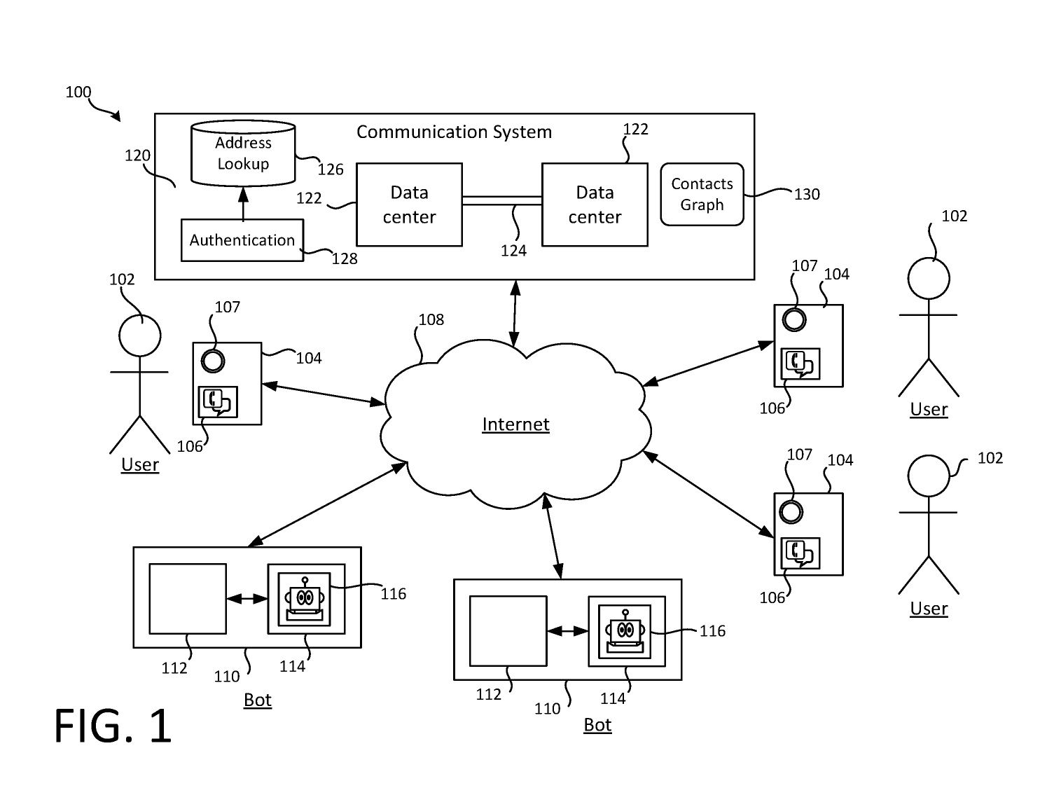

FIG. 1 shows schematic a block diagram of a computer system 100. The computer system 100 comprises a communication system 120, a plurality of user devices 104, and a plurality of computer devices 110, each of which is connected to a packet based computer network 108, such as the Internet. The communication system 120 is shown to comprise a plurality of data centers 122.

Each of the user devices 104 is operated by a respective user 102, and comprises a processor configured to execute a communication client application 106. Herein, the term processor means any apparatus configured to execute code (i.e. software), and may for example comprise a CPU or set of interconnected CPUs.

The communication system 120 has functionality for effecting real-time communication events via the network 108 between the users 102 using their communication clients 106, such as calls (e.g. VoIP calls), instant messaging (“chat”) sessions, shared whiteboard sessions, screen sharing sessions etc. A real-time communication event refers to an exchange of messages between two or more of the users 102 such that there is only a short delay (e.g. two seconds or less) between the transmission of a message from one of the clients 106 and its receipt at the other client(s) of the users 102 participating in the communication event. This also applies to transmission/receipt at the computer devices 110 in the case that at least one of the participants is a bot 116—see below.

The term “message” refers generally to content that is communicated between the users 102, plus any header data. The content can be text (character strings) but could also be real-time (synchronous) audio or video data. For example, a stream of messages carrying audio and (in some cases) video data may be exchanged between the users in real-time to effect a real-time audio or video call between the users.

For example, the communication system 12 may be configured to implement at least one communication controller, such as a call controller or messaging controller, configured to establish a communication event between two or more of the user's 102, and to manage the communication event once established. For example, the call controller may act as an intermediary (e.g. proxy server) in a signaling phase in which a communication event is established between two or more of the users 102, and may be responsible for maintaining up-to-date state data for the communication event once established.

The messaging controller may receive instant messages (that is, messages with text content) from each user in an instant messaging communication session, and relay the received messages to the other user(s) participating in the session. In some cases, it may also store copies of the messages centrally in the communication system 120, so they are accessible to the users at a later time, possibly using a different user device.

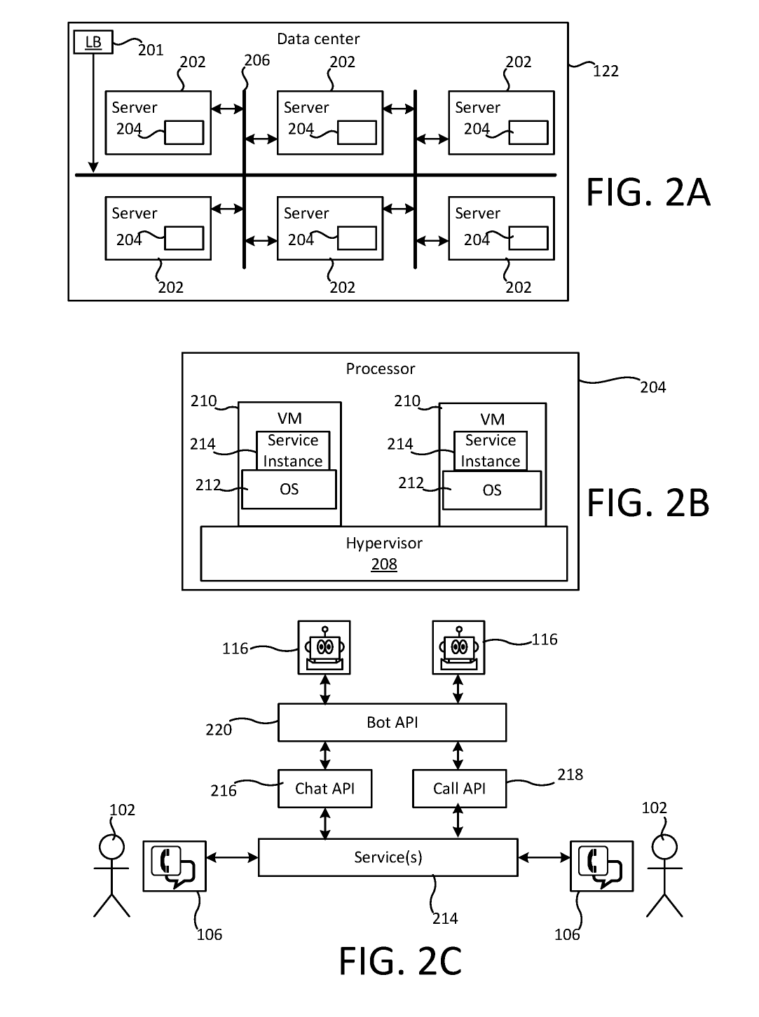

The controllers can for example be implemented as service instances or clusters of services instances (214, FIG. 2B—see below) executed at the data centers 122.

The communication system 120 is also configured to implement an address look-up database 126, and an authentication service 128. Although shown separately from the data centers 122, in some cases these may also be implemented at the data centers 122. The authentication service 128 and lookup database 126 cooperate to allow the users 102 to log in to the communication systems at their user devices 104 using their clients 106. The user 102 enters his credentials at his user device 104, for example a user identifier (ID)—e.g. username—and password, which are communicated to the authentication service 128 by the client 106. The authentication 128 service checks the credentials and, if valid, allows the user device 102 to log on to the communication system, for example by issuing an authentication token 107 to the user device 104. The authentication token 107 can for example be bound to the user device 104, such that it can only be used by that user device 104. Within the communication system 120, the authentication token 106 is associated with that user's user ID and can be presented to the communication system 120 thereafter as proof of the successful authentication whenever such proof is required by the communication system 120.

In addition, the authentication service 128 generates in the address lookup database 126 an association between a network address of the authenticated user device (e.g. IP address of the user device 104 or transport address of the client 106) and the user's user ID. This allows other users to use that user's user ID to contact him at that that network address, subject to any restriction imposed by the communication system 120. For example, the communication system may only allow communication between users who are mutual contacts within the communication system 120.

The communication system 120 also comprises a current user database (contacts graph) 130, which is a computer implemented data structure denoting all current user's 108 (that is, comprising a record of all active user IDs) of the communication system 120.

The contacts graph 130 also denotes contact relationships between the users 102, i.e. a data structure denoting, for each of the users 108 of communication system, which other(s) of the users 108 are contacts of that user. Based on the contacts graph 130, each of the client 106 can display to its user 102 that user's contacts, which the user can select to instigate a communication event with, or receive messages from in a communication event instigated by one of his contacts.

Note the databases 126 and 130 can be implemented in any suitable fashion, distributed or localized.

Each of the computer devices 110 comprises computer storage in the form of a memory 114 holding at least one respective code module, and at least one processor 112 connected to the memory. The code module is thus accessible to the processor 112, and the processor 112 is configured to execute the code module to implement its functionality.

The term computer storage refers generally to an electronic storage device or set of electronic storage devices (which may be geographically localized or distributed), such as magnetic, optical or solid state electronic storage devices.

Each of the code modules is configured to implement, when executed on the processor 112, a respective bot 116, equivalently referred to herein as a software agent.

As described in further detail below, the computer system 100 has functionality in the form a bot API (application programming interface) to allow the bots 116 to participate in communication events effected by the communication system 120, along with the users 102.

A bot is an autonomous computer program, which automatically generates (without any direct oversight by a human) meaningful responses to messages sent from the clients 106 during a communication event in which the bot is also participating. That is, the bot autonomously responds to such messages in a manner akin to that of a human, to provide a natural and intuitive conversational experience for the user(s).

A communication event effected by the communication system 120 can be can be conducted between one of the users 102 and one of the bots 116, i.e. as a one-to-one communication event with two participants, one of whom is a bot. Alternatively, a communication event effected by the communication system 120 can be between multiple users 102 and one bot 116, multiple users 102 and multiple bots 116, or one user 102 and multiple bots 116, i.e. as a group communication event with three or more participants.

By way of example, two data centers 122 of the communication system 120 are shown, which are collocated and connected to each other by means of a dedicated, backbone connection 124 between the two data centers 122 dedicated inter-data center connection). For example, a fiber-optic cable or set of fiber-optic cables between the two data centers. This allows data to be communicated between the two collocated data centers with very low latency, bypassing the network 108.

FIG. 2A shows an example configuration of each of the data centers 122. As shown, each data center 122 comprises a plurality of server devices 202. Six server devices 202 are shown by way of example, but the data Center may comprise fewer or more (an possibly many more) server devices 202 (and different data centers 122 may have different numbers of server devices 202). The data center 122 has an internal network infrastructure 206 to which each of the servers 202 is connected, and which provides an internal service-to-service connection between each pair of servers 202 in the data center 122. Each of the servers 202 comprises at least one processor 204. A load balancer 201 receives incoming messages from the network 108, and relays each to an appropriate one of the server devices 202 via the internal network infrastructure 206.

To allow optimized allocation of the processing resources of the processors 204, virtualization is used. In this respect, as shown in FIG. 2B, each of the processors 204 runs a hypervisor 208. The hypervisor 208 is a piece of computer software that creates, runs and manages virtual machines, such as virtual servers 210. A respective operating system 212 (e.g. Windows Server™) runs on each of the virtual servers 210. Respective application code runs on each operating system 210, so as to implement a service instance 214.

Each of the service instances 214 implements respective functionality in order to provide a service, such as a call control or messaging control service. For example, a cluster of multiple service instances 214 providing the same service may run on different virtual servers 210 of the data center 122 to provide redundancy in case one fails, with incoming messages being relayed to service instances in the cluster selected by the load balancer 201. As indicated above, a controller of the communication system 120, such as a call controller or messaging controller, may be implemented as a service instance 214 or cluster of service instances providing a communication service, such as a call control or messaging control service.

This form of architecture is used, for example, in so-called cloud computing, and in this context the services are referred to as cloud services.

FIG. 2C shows an example software architecture of the communication system 120, such that the users 102 can participate in communication events with the bots 116 using the communication infrastructure provided by the communication system, including the communication infrastructure of the communication system 120 described above with reference to FIGS. 1 to 2B.

As indicated, one or more communication services 214 provided by the communication system 122 allow the users 102 to participate in communication events with one another.

So that the bots 116 can also participate in the communication events, a bot interface in the form of a bot API 220 is provided. Separate messaging (chat) and call APIs 216, 218 are provided, which provide a means by bots can participate in messaging session (text-based) and calls (audio and/or video) respectively. If any when a communication service 214 needs to communicate information to one of the bots 116 in a chat (text) or call (audio/video), it instigates one or more functions of the chat API 216 and call API 218 as appropriate, which in turn instigates one or more functions of the bot API 220. In the other direction, of and when the bot 116 needs to transmit information to one or more of the users 102 in a chat or call, the bot instigates one or more functions of the bot API 220, which in turn instigates one or more functions of the chat or call API 216, 218 as appropriate.

Each of the APIs 216, 218, 220 can for example be implemented as code executed on a processor or processors of the communication system 120—for example, in the form of a library—configured to provide a set of functions. Depending on where the API is called from, these functions may be instigated (i.e. called) locally, or they may be called remotely via a network interface(s) coupled to the processor(s), for example via the network 102 or using low latency back-end network infrastructure of the communication system 120, such as the internal data center network infrastructure 206 and inter-data center backbone 124. For “internal” API calls made from within the communication system 120, it may be preferable in some contexts to use only the latter where possible.

For example, the bot API 220 can be configured to provide a function (or respective functions), which can be instigated by the relay 214R via the call API 218 or chat API 216 as applicable to fetch a set of bot descriptions from the bot storage service. Each bot description can for example comprise an identifier of one of the bots (bID) and any additional information about the identified bot for use in communication with that bot.

In any event, each of the APIs can generally be implemented as code executed on a processor accessible to at least two computer programs (at least one bot 116, and at least service instance 214)—which may or may not be executed on the same processor or processors—and which can be used by each of those programs to communicate with the other of those programs.

The bot API 220 allows the bots 116 to participate in communication events effected by an existing communication system, such as Skype, FaceTime, Google Voice, Facebook chat etc. That is, it provides a means by which functionality for communicating with bots as well as users can be incorporated into a communication system originally designed for users only, using the existing, underlying communications infrastructure of the communication system (such as its existing authentication, address lookup and user interface mechanisms).

In this sense, the bots 116 are third party systems from the perspective of the communication system, in the sense that they can be developed and implemented independently by a bot developer, and interface with the communication system 120 via the bot API 220.

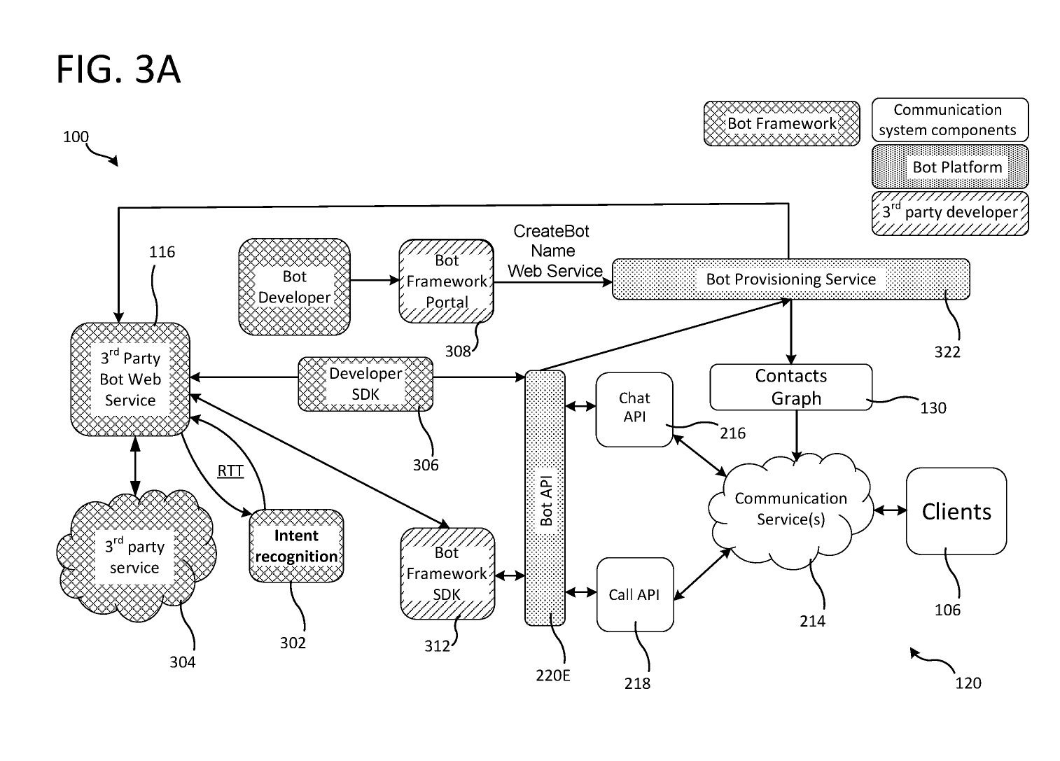

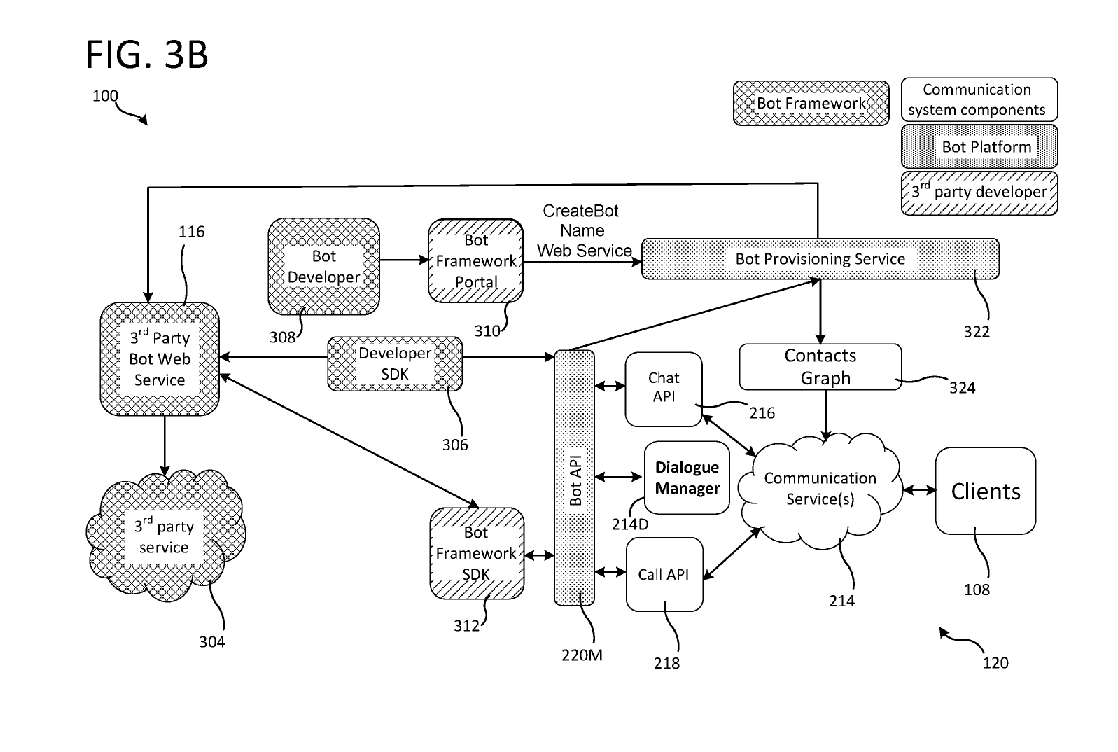

FIG. 3A shows additional details one example software architecture of the computer system 100, In addition to the components already described with reference to FIGS. 1 and 2A-C, for which the same reference signs are used, additional software components are shown. FIG. 3A represents an existing type of architecture, and is not intended to illustrate an embodiment of the present invention as such. Rather, FIG. 3A and the accompanying description provides a context for explaining modifications that can be made to the system in accordance with the present invention.

In FIG. 3A a first example bot API 220E is shown, which is an existing type of bot API.

To create an customize a bot 116 that users 102 of the communication system 120 can communicate with using the communication infrastructure of the communication system 120, the bot developer can use a bot framework portal 308 to instigate a bot creation instruction to a bot provisioning service 322, which may also be implemented as a cloud service. For the creation of his bot 116, the bot developer can use a bot framework SDK (software developers kit) 312 provided by the operator of the communication system 120, or alternatively he may build his on SDK 306 that is compatible with the bot API 220E. SDK stands for software development kit.

The bot provisioning service 322 interacts with the contacts graph 130, so as to add the newly-created bot 116 as a “user” of the communication system 120, in the sense that the bot 116 appears as a user within the communication system to the (real) users 108. For example, such that a user 102 can add the bot 116 as a contact, by instigated a contact request at his client 116 (which may be automatically accepted). Alternatively, any user 102 may be able to communicate with a bot 116 using his client 116 without having to add that bot as a contact explicitly, though the option to do so may still be provided for convenience. In any event, the user 102 is able to initiate a communication event, such as a chat or call, with the bot 116 as he would with another real, human user 102 of the communication system 120.

Each of the bots 116 thus has a unique identity within the communication system 120, as denoted by an identifier “bID” of that bot in the contacts 130 that is unique to that bot within the system, where the integer “M” is used to denote the total number of bots having such an identity within the communication system 120 i.e. there are M unique bot identifiers in the contacts graph 130, where “bIDm” denotes the mth bot identifier.

The integer N denotes the total number of users who have an identity within the communication system 120, i.e. there are N human user identifiers in the contacts graph 130, wherein “uIDn” denotes the nth user identifier.

Thus, to actual human users 108 of the communication system, there appear to be N+M “users”−N humans 108, plus M bots 116.

One bot 116 is shown in FIGS. 3A and 3B by way of example, but it will be appreciated that the following description pertains to each of the multiple bots 116 individually.

The bot 116 communicates with a third party service 304 (i.e. outside of the domain and infrastructure of the communication system 120), which can be one of an extensive variety of types, for example an external search engine, social media platform, e-commerce platform (e.g. for purchasing goods, or ordering takeaway food and drinks etc.). The bot 116 acts as an intermediary between the user's 108 and the third party service, so that user can access the third party service in an intuitive manner by way of a natural conversation with the bot 116. That is, the bot 116 constitutes a conversational (i.e. natural language) interface between the user 102 and the third part service 304.

The user's engagement with the bot 116 is conversational in the sense that the precise format of his request to the bots is not prescribed. For example, suppose the third party service 304 is an online takeaway service, and the user want's to order a Pizza.

In this case, the user 102 can, say, instigate a chat message to the bot 116 using his communication client 106. The user need not concern himself the semantics of the textual content of the message and can, for example, start by saying to the bot 116 “please can I order a Pizza?”, or “Hi, I'd like a pizza please” or “order Pizza”—that is, by expressing his general intent to order a pizza to the bot without additional details at this stage—or with a more specific request, such as “I'd like a pepperoni pizza”, or “please deliver a pizza in two hours to my home address”—that is expressing additional details of his intent.

In order to interpret these correctly, the bot need to understand the user's intent, in whatever manner and to whatever level of detail the user 102 has chosen to express it. To this end, some form of intent recognition needs to be applied to the content of the message, in order to identify the user's intent to the extent it can be identified—e.g. to identify that the user wants to order a pizza but has specified no details, or that he want to order a specific type of pizza but has not specified a time or place, or that he wants a pizza at a specific time and place but has not specified details of the pizza etc.

Intent recognition is known in the art, and for that reason details of specific intent recognition processes will not be described herein.

For example, at present, third party intent recognition services are available, with which a bot can interact. FIG. 3A shows an example of this, by way of intent recognition service 302.

In the existing architecture of FIG. 3A, when the bot receives, say, a chat message from a user 102 via the communication system 120 and existing bot API 220E, in response, the bot 116 communicates at least the text content of the message to the intent recognition service 302. The intent recognition service 302 applies intent recognition parsing to the text content, in order to identify the intent of the user as best it can, and communicates the results back to the bot 116. This involves a round trip of signaling incurring a cost of one round trip time (RTT). Particularly as this signaling typically takes place via the public Internet, the round trip time can be significant. This introduces a delay between receiving the message and the bot 116 being able to respond, which can be significant and detrimental to the user experience, as it breaks the natural flow of conversation that the bot is intended to provide.

FIG. 3B shows how the existing software architecture of FIG. 3A can be modified in a novel manner, according to an embodiment of the present invention.

In place of the existing bot API 220E, a modified bot API 220M is shown. The communication system 120 also comprises an additional component, in the form of a dialogue manager 214D. The dialogue manager 214D can also be implemented a service instance or service instance cluster running in one of the data centers 122, for example as another cloud service.

Notably the dialogue manager 214D is a component of the communication system 120 itself, and is configured to perform intent recognition in place of the third party service 304 of FIG. 3A. This allows the messaging flow to be modified such intent recognition is applied to a message received from one of the user's 102 within the communication system 120 itself, before the message is communicated to the bot.

Preferably, the dialogue manager 214D that processes the message is implemented in the same data center 122 as the processor 204 of the communication system 120 at which the message is received, and in some cases may even be implemented on that same processor 204. Where implemented in the same datacenter on a different one of the processors 204, the low latency internal network infrastructure 206 can be used for communication with the dialogue manager 214D. Alternatively the dialogue manager 214D can be implemented in a collocated data center such that content of the message can be transmitted to dialogue manager 214D via the dedicated backbone connection 124 (see FIG. 1).

In any event, content of a message received from a user 102 at one of the processors 204 of the communication system is communicated to the dialogue manager 214D directly, i.e. not via the network 108 which as noted may be the Internet (i.e. directly as in not via the public Internet in that scenario). That is, implementing the dialogue manager 214D within the communication system 120 allows low-latency internal network infrastructure of the communication system 120 (e.g. 206 and/or 124) to be used to provide direct, low-latency communication of the message content to the dialogue manager 214D as needed using the internal network infrastructure of the communication system 120.

To enable this, the modified bot API 220M can for example comprise an additional function, which the chat or call API 216, 218 can instigate, and which when instigated on a received message communicates content of the received message to the dialogue manager 214D directly (intent recognition function).

As noted, the dialogue manager 214D applies an intention recognition process to the content it received in this manner. The intent recognition process operates on the same principles as outlined above, but importantly is performed within the communication system 120 itself and before any information form the message 402 has been transmitted to the bot 116.

The aim of the intent recognition processing is to determine a user's intent in any given context.

Implementing the intent recognition processing also allows the resources available to the provider of the communication system 120 to be leveraged, which may be significantly more extensive than those available to bot developers or other third parties for an established communication system with global reach. This allows more complex and accurate (but resource intensive) intent recognition processing, and for optimization in terms of high throughput and low latency.

The intent recognition process incorporates natural language processing, and uses a predetermined set of intents and predetermined set of associated entities, i.e. things to which the intents can apply. These sets may be extensive to provide comprehensive intent recognition, for example several hundred intents and entities in various domains.

Once complete, it instigates another function of the modified bot API 220M, in order to transmit another message comprising an identifier(s) of the determined intent to the bot 116, which in the examples described below is a modified version of the message originally received form the user 102 (by contrast, in the existing architecture of FIG. 3A, a function of this kind would instead be instigated by the call or chat API 218, 216 instead, to communicate the original message to the bot 116).

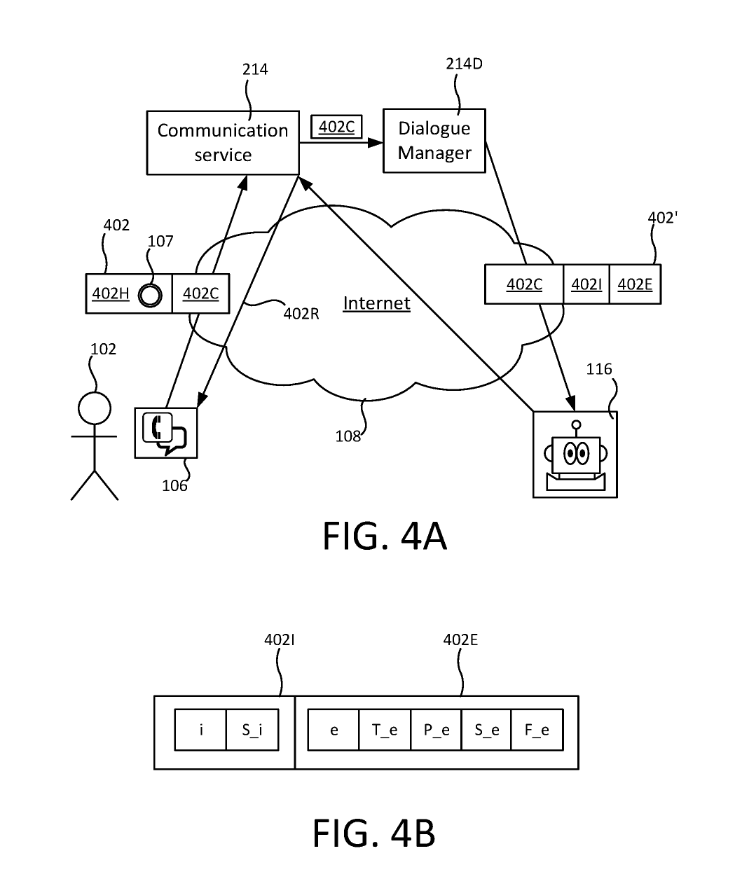

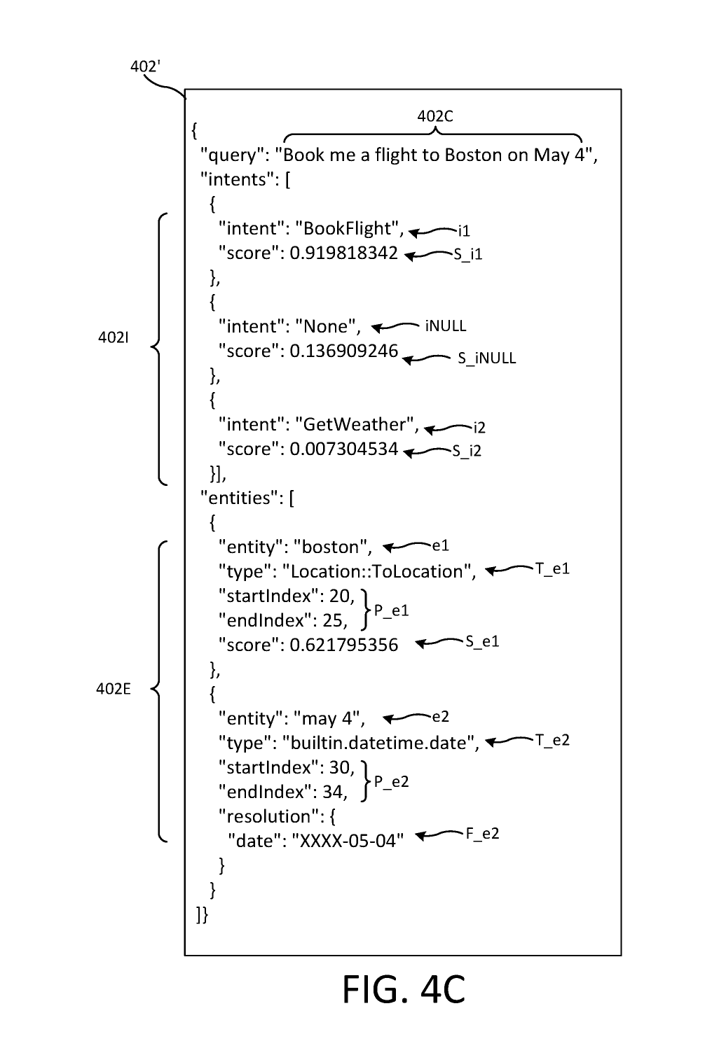

FIG. 4A shows an example message flow between a client 106 of user 102 and a bot 116 (target bot) via the dialogue manager 214D, in accordance with the novel architecture of FIG. 3B.

A message 402, is transmitted from the client 106 to the communication system 120, where it received by a communication service instance 214. The message 402 comprises content 402C, which in this example is text data in the form of a character string but which, as noted, could also be real-time audio data or real-time video data. The message 402 also comprises header data 402H, which can for example include the authentication token 107 so that the communication system 120 knows to accept the message 402. The message also comprises an identifier of the target bots 116.

The communication service instance 214 transmits at least the message content 402C to the dialogue manager 214D directly as described above. The dialogue manager 214D applies intent recognition to the message content 402C, by applying intent recognition parsing to the text content 402C.

Once the intent recognition is complete, the dialogue manager 214D transmits a modified version of the message (denoted 402′) to the bot, which includes, in addition to the message content 402C itself, recognized intent data 402I and associated entity data 402E generated by applying the intent recognition processing to the message content 402C. Alternatively, the recognized intent data 402I and entity data 402E may be sent in a message which does not include the original message content 402C. It may be preferable to include at least some of the original content 402C in some cases, to allow the bot 116 to provide richer features. However, in many cases, it is expected that the determined intents and entities alone will be enough for the bot 116 to perform its intended function.

The bot 116 receives the modified message 402′, and uses the recognized intent data 402I and associated entity data 402E to generate an appropriate response 402R automatically, taking into account the user's intent and the object of his intent.

Similar techniques could be applied to audio data, by first applying speech-to-text to the audio data, and processing the resulting text, by the dialogue manager 214D, using intent recognition parsing in the same manner. Intent recognition processing of video data can be based on, for example, feature recognition applied to frame images of the video data.

The message 402′ may for example be transmitted to the bot 116 using a push mechanism, such as a Webhook.

With reference to FIG. 4B, the recognized intent data 402I comprises at least one intent identifier “i”, which identifies one of the set of predetermined intents, and an associated score S_i, denoting a probability that this corresponds to the user's true intent.

The associated entity data 402E comprises an entity identifier “e”, which identifies one of the set of predetermined entities, which in turn constitutes the likely object of the user's intent. The entity data 402E and may also comprise one or more of the following:
an associated score S_e denoting a probability that the identified entity is indeed the entity intended by the user 102,
a type T_e of the identified entity,
a description F_e of the entity in a standardised format,
an identifier P_e of a position at which the entity is mentioned in a character string of the content, in the case of text content 402C.

The entity can for example be a particular item, a date or a person.

FIG. 4C shows one example of a modified message 402′ to aid illustration, which is a JSON message.

In this example, the original content 402C is the text string:
“Book me a flight to Boston on May 4”

A first intent identifier i1 “BookFlight” denotes an intent to book a flight, and has a high associated score for reasons that will be evident. A second intent identifier i2 denotes an intent to obtain weather data, which has a very low score for reasons that are again evident. A null intent identifier i_NULL has a relatively low score, as it is relatively unlikely that the user has no intent in this case.

Two entities are identifier—“boston” (entity identifier e1) and “may 4” (entity identifier e2), of type “Location::ToLocation”—i.e. not just any location but specifically one the user 102 want to go to—and “builtin.datetime.date” which is a specific type of date.

Because it may be useful for the bot 116 to know, for each entity e1, e2 a respective location identifier P_e1, P_e2 is included in the entity data 402E, each in the form of an integer pair denoting the start and the end of the corresponding characters in the original character string 402C.

The entity data 401I also includes an associated score S_e2 for the “boston” entity e1 denoting a probability that this is the entity the user intended, and a re-formatted version of the “may 4” date entity e2 in a standardized format “XXX-05-04” wherein the characters “XXXX” denote the fact that no year has been recognized in the original content 402C.

An objective of the software architecture of FIG. 3B is to allow bot developers receive from users 102 content via the communication system 120 augmented with context from AI tools implemented within the communication system 120. Integrating such additional tools directly into communication system 120 alleviates the developer from calling additional services (e.g. 302, FIG. 3A). Additionally the communication system 120 may be best placed to determine the media type and enriching the message with appropriate context, due to its extensive resources and extensive user base from which a wealth of intents can be learned.

The content 402C of a chat message 402 may also comprise synchronous media types (e.g. images, or audio or video clips), which can for example automatically parsed for context via third party services. This parsing can be instigate by the dialogue manager 214D.

Synchronous media is delivered with rich types detailing describing the conversation, based on real-time intent processing, and e.g. automated speech to text transcription, where needed.

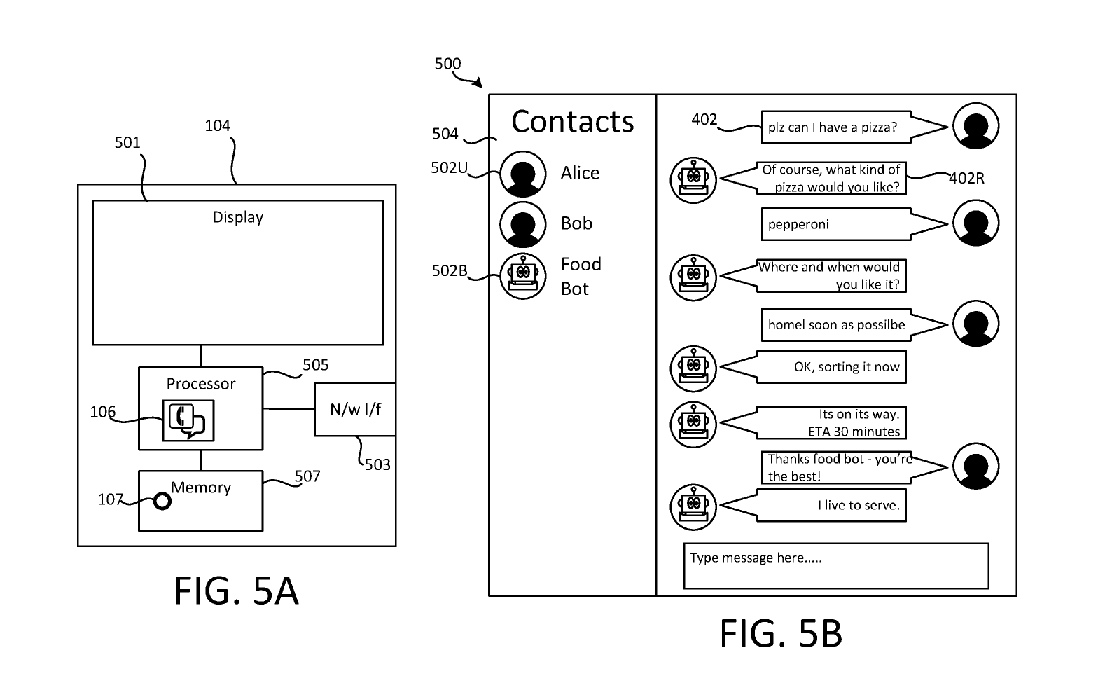

FIG. 5A a schematic block diagram of a user device 104. The user device 104 is a computer device which can take a number of forms e.g. that of a desktop or laptop computer, mobile phone (e.g. smartphone), tablet computing device, wearable computing device, television (e.g. smart TV), set-top box, gaming console etc. The user device 104 comprises computer storage in the form of a memory 507, a processor 505 to which is connected the memory 507, one or more output devices, such as a display 501, loudspeaker(s) etc., one or more input devices, such as a camera, microphone, and a network interface 503, such as an Ethernet, Wi-Fi or mobile network (e.g. 3G, LTE etc.) interface which enables the user device 104 to connect to the network 108. The display 501 may comprise a touchscreen which can receive touch input from a user of the device 6, in which case the display 24 is also an input device of the user device 6. Any of the various components shown connected to the processor may be integrated in the user device 104, or non-integrated and connected to the processor 505 via a suitable external interface (wired e.g. Ethernet, USB, FireWire etc. or wireless e.g. Wi-Fi, Bluetooth, NFC etc.). The processor 505 executes the client application 106 to allow the user 102 to use the communication system 120. The memory 507 holds the authentication token. The client 106 has a user interface for receiving information from and outputting information to a user of the user device 104, including during a communication event such as a call or chat session. The user interface may comprise, for example, a Graphical User Interface (GUI) which outputs information via the display 501 and/or a Natural User Interface (NUI) which enables the user to interact with a device in a “natural” manner, free from artificial constraints imposed by certain input devices such as mice, keyboards, remote controls, and the like. Examples of NUI methods include those utilizing touch sensitive displays, voice and speech recognition, intention and goal understanding, motion gesture detection using depth cameras (such as stereoscopic or time-of-flight camera systems, infrared camera systems, RGB camera systems and combinations of these), motion gesture detection using accelerometers/gyroscopes, facial recognition, 3D displays, head, eye, and gaze tracking, immersive augmented reality and virtual reality systems etc.

FIG. 5B shows an example of a graphical user interface (GUI) 500 of the client 106, which is displayed on the display 501.

The GUI includes a contact list 504 which is displayed in a portion of an available display area of the display 501. Multiple display elements are shown in the contact list, each representing one of the user's contacts, which includes display elements 502U, 502B representing a human contact (i.e. another of the users 102) and a bot contact (i.e. one of the bots 116) respectively. That is, the bot 116 is displayed in the contact list 504 along with the user's human contacts.

The user can send chat messages 402 to the bot via the GUI 500, which are displayed in a second portion of the display area along with the bot's responses 402R, generated based on the intents and entities recognized by the dialogue manager 214D.

The terms “module” and “component” refer to program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors. The instructions may be provided by the computer-readable medium to a processor through a variety of different configurations. One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, solid-state (e.g. flash) memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer system comprising:
computer storage holding at least one code module configured to implement a bot, and at least one processor configured to execute the code module;
a communication system for effecting communication events between users of the communication system;
a bot interface for exchanging messages between the communication system and the bot; and
a dialogue manager;
wherein the communication system is configured to transmit, to the dialogue manager directly, content of a first message received at a processor of the communication system from a user of the communication system;
wherein the dialogue manager is configured to apply an intent recognition process to the content of the first message to generate at least one intent identifier, and transmit a second message comprising the intent identifier to the bot using the bot interface; and
wherein the bot is configured, in response to receiving the second message, to automatically generate a response using the intent identifier received in the second message, and transmit the generated response to at least the user.

2. A computer system according to claim 1, wherein the processor of the communication system is located in a data center, and the dialogue manager is implemented by a processor located in the same data center, the content being transmitted via an internal service-to-service connection of the data center.

3. A computer system according to claim 1, wherein the processor of the communication system is located in a data center, and the dialogue manager is implemented by a processor located in a collocated data center, the content being transmitted via a dedicated backbone connection between the data center and the collocated data center.

4. A computer system according to claim 1, wherein the dialogue manager is implemented on the processor that receives the message.

5. A computer system according to claim 1, wherein the dialogue manager is configured to determine a score for the intent identifier, which is included in the second message.

6. A computer system according to claim 1, wherein the dialogue manager is configured to determine at least one entity associated with the intent data, and to generate an identifier of the entity, which is included in the second message.

7. A computer system according to claim 6, wherein the dialogue manager is configured to include in the second message:
a type of the entity,
a score for the entity,
a description of the entity in a standardised format, and/or
an identifier of a position at which the entity is mentioned in a character string of the content.

8. A computer system according to claim 1, wherein the bot interface is an API and the content of the first message is transmitted directly to the dialogue manager by the communication system instigating an intent recognition function of the bot API.

9. A computer system according to claim 8, wherein the communication system comprises a communication API and the communication service is configured to instigate a function of the communication API in response to receiving the first messages, which causes the communication API to instigate the intent recognition function to transmit the content of the first message directly to the dialogue manager.

10. A computer system according to claim 1, wherein the content of the message comprises a character string.

11. A computer system according to claim 1, wherein the content of the message comprises audio and/or video data.

12. A computer system according to claim 1, wherein the audio and/or video data is real-time data.

13. A computer system according to claim 1, wherein the first message is transmitted from the user to the communication system and the second message is be transmitted from the dialogue manager to the bot via a packet based computer network, wherein the first message is not transmitted from the processor to the dialogue manager via that network.

14. A computer system according to claim 13, wherein the network is the Internet, such that the first message is not transmitted from the processor to the dialogue manager via the Internet.

15. A computer system according to claim 1, wherein the bot is configured to transmit the generated response to at least the user using the bot interface.

16. A computer system according to claim 15 wherein said transmitting of the generated response by the bot to the user using the bot interface comprises using the bot interface to transmit the response to the communication system for relaying to the user, wherein the communication system is configured to relay the response to the user.

17. A computer-implemented method of effecting a communication event between at least one user of a communication system and at least one bot, the at least one bot being implemented by at least one code module executed on at least one processor, the method comprising implementing, by the communication system, the following steps:
receiving a first message at a processor of the communication system from the user of the communication system;
transmitting directly to a dialogue manager of the communication system content of the first message received at the processor;
applying, by the dialogue manager, an intent recognition process to the content of the first message to generate at least one intent identifier; and
transmitting from the dialogue manager to the bot a second message comprising the intent identifier, using a bot interface of the communication system, the intent identifier in the second message for use by the bot in automatically generating a response to the second message for transmission to the user.

18. A method according to claim 17, wherein the processor of the communication system is located in a data center, and the dialogue manager is implemented by a processor located in the same data center, the content being transmitted via an internal service-to-service connection of the data center.

19. A method according to claim 17, wherein the processor of the communication system is located in a data center, and the dialogue manager is implemented by a processor located in a collocated data center, the content being transmitted via a dedicated backbone connection between the data center and the collocated data center.

20. A computer program product comprising system code stored on a computer readable storage medium, the system code for effecting a communication event between at least one user of a communication system and at least one bot, the at least one bot being implemented by at least one code module executed on at least one processor;
wherein a first portion of the system code is configured when executed at the communication system to implement a dialogue manager;
wherein a second portion of the code is configured when executed on a processor of the communication system to implement steps of receiving a first message at the processor from the user of the communication system, and transmitting directly to the dialogue manager content of the first message received at the processor; and
wherein the dialogue manager is configured to apply an intent recognition process to the content of the first message to generate at least one intent identifier, and to transmit to the bot a second message comprising the intent identifier, using a bot interface of the communication system, the intent identifier in the second message for use by the bot in automatically generating a response to the second message for transmission to the user.
